(19) United States
(12) Patent Application Publication
(10) Pub. No.: US 2005/0170864 A1
(43) Pub. Date: Aug. 4, 2005

(54) Mobile switching center feature group

(76) Inventors: Deborah Lewandowski Barclay, Winfield, IL (US); David S. Benco, Winfield, IL (US); Sanjeev Mahajan, Naperville, IL (US); Thomas Lee McRoberts, Naperville, IL (US); Raymond Leroy Ruggerio, Glenview, IL (US)

Correspondence Address: PATTI & BRILL, ONE NORTH LASALLE STREET, 44TH FLOOR, CHICAGO, IL, 60602, US

(21) Appl. No.: 10/767,806

(22) Filed: Jan. 29, 2004

(51) Int. Cl. H04M 1/00

(52) U.S. Cl. 455/560; 455/550.1

(57) ABSTRACT

A mobile switching center of an apparatus in one example allows a user of a mobile communication device to assign one or more members to a feature group that is employable by the mobile switching center to provide a communication feature to the user.

### CROSS-REFERENCE TO RELATED APPLICATIONS

This application contains subject matter that is related to the subject matter of the following applications, which are assigned to the same assignee as this application. The below-listed applications are hereby incorporated herein by reference in their entireties:

“MOBILE COMMUNICATION DEVICE CALL BARGE-IN,” by Barclay, et al., Serial No. ______ co-filed herewith.

### TECHNICAL FIELD

The invention relates generally to mobile networks and more particularly to communication features.

### BACKGROUND

Users of mobile communication devices have several communication features available for handling incoming calls. Exemplary communication features comprise call waiting, call forwarding, and call blocking. Upon activation of a communication feature by the user, all incoming calls in one example are treated as a single group for a communication feature.

When engaged in an active call, users of mobile communication devices are often reluctant to switch to another incoming call. If the user does not have sufficient time to handle an interruption in the active call, the user may miss the other incoming call. Missing the other incoming call is inconvenient for the user if the incoming call is from a preferred user, for example, family or close friends. If the user had knowledge that the incoming call was from a preferred user before interrupting the active call, the user would be more likely to answer the incoming call. For example, the preferred user would receive preferred treatment from the user.

If the user had knowledge that the incoming call was from other than a preferred user, the user may desire a different communication feature to be performed on the incoming call. For example, if the user does not wish to be disturbed by a non-preferred user, the incoming call would be blocked. Alternatively, a preferred user would receive preferred treatment and be connected to the user. However, the user is unable to determine which communication feature is performed on an incoming call on a per-call basis.

Thus, a need exists for a promotion of preferred treatment of preferred users.

### SUMMARY

The invention in one implementation encompasses an apparatus. The apparatus comprises a mobile switching center that allows a user of a mobile communication device to assign one or more members to a feature group that is employable by the mobile switching center to provide a communication feature to the user.

Another implementation of the invention encompasses a method. A calling user is identified as one of one or more members of a user-defined feature group for a communication feature. The communication feature is performed on an incoming call from the calling user.

A further implementation of the invention encompasses an article. The article comprises one or more computer-readable signal-bearing media. The article includes means in the one or more media for identifying a calling user as one of one or more members of a user-defined feature group for a communication feature. The article includes means in the one or more media for performing the communication feature on an incoming call from the calling user.

### DESCRIPTION OF THE DRAWINGS

Features of exemplary implementations of the invention will become apparent from the description, the claims, and the accompanying drawings in which:

FIG. 1 is a representation of one implementation of an apparatus that comprises a mobile switching center, a mobile communication device, and one or more communication devices.

FIG. 2 is a representation of an exemplary logic flow for the apparatus of FIG. 1 and illustrates a call waiting feature performed by the mobile switching center.

FIG. 3 is a representation of an exemplary message flow for the apparatus of FIG. 1 that illustrates a call waiting feature performed by the mobile switching center.

### DETAILED DESCRIPTION

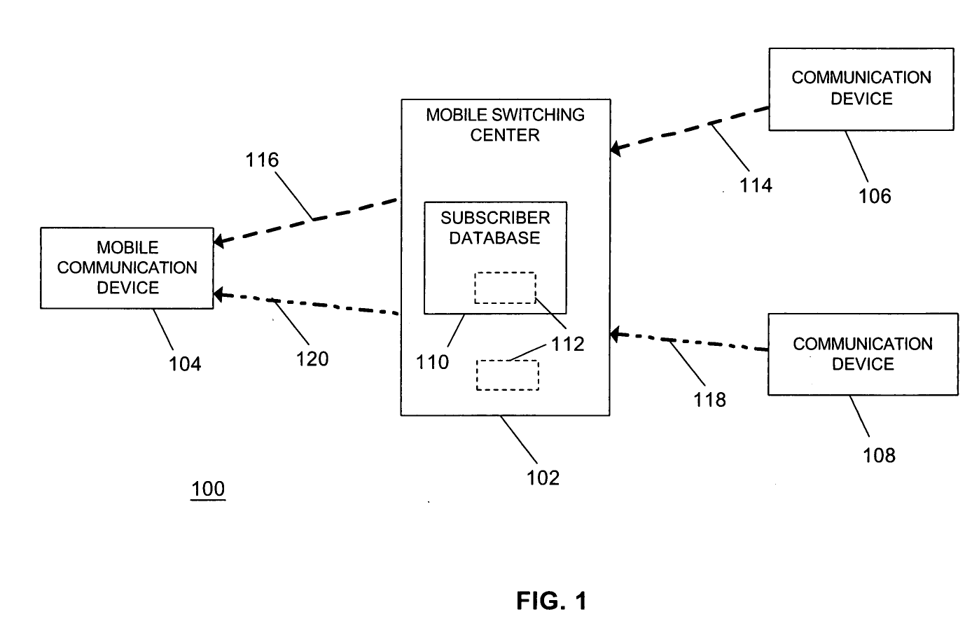

Turning to FIG. 1, an apparatus 100 in one example comprises a mobile switching center 102, a mobile communication device 104, and one or more communication devices 106 and 108. The mobile switching center 102 synchronizes with the mobile communication device 104. For example, the mobile switching center 102 routes calls to and from the mobile communication device 104.

The mobile switching center 102 allows a mobile user of the mobile communication device 104 to assign one or more members to a feature group. For example, the feature group comprises a user-defined feature group. The mobile switching center 102 employs the feature group to provide a communication feature to the mobile user. Exemplary communication features comprise a call waiting feature, a call forwarding feature, and a call barge-in feature. A description of operation of the call waiting feature is presented herein, with further details of the barge-in feature provided in the above-incorporated Application Ser. No. ______. The mobile switching center 102 in one example gives preferred treatment to members of the user-defined feature group. Exemplary preferred treatment comprises a longer call waiting period, a preferred call waiting indication, call forwarding to an unlisted number, and an ability to barge-in on a pre-existing call.

The mobile switching center 102 in one example comprises a subscriber database 110. In another example, the subscriber database 110 is remotely located from the mobile switching center 102. The mobile switching center 102 and/or the subscriber database 110 in one example comprise an instance of a recordable data storage medium 112, as described herein. For example, the mobile switching center 102 and/or the subscriber database 110 store the feature group in the recordable data storage medium 112.

The mobile communication device 104 in one example comprises a mobile phone and/or personal digital assistant. The mobile switching center 102 in one example cooperates with the mobile communication device 104 to provide an interface to the mobile user. The interface allows the mobile user to assign one or more members to the feature group for the communication feature, as described herein. Exemplary interfaces comprise one or more of a voice interface, a dual tone multi frequency (“DTMF”) interface, a graphical interface, a keypad interface, and a touchpad interface.

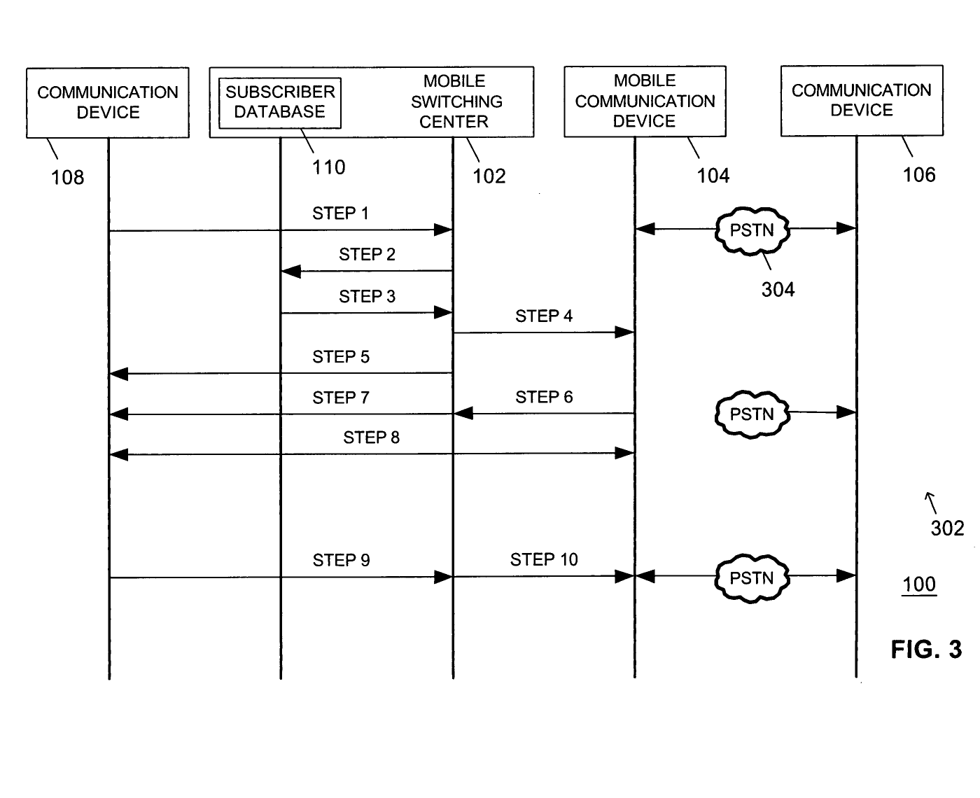

The communication devices 106 and 108 in one example comprise terminals of a public switched telephone network 304 (“PSTN”, FIG. 3), telephony devices, and other mobile communication devices. The communication devices 106 and 108 comprise an identifier, for example, a calling party number, a mobile station identification, or an internet protocol address. The mobile switching center employs the identifier to determine an identity of a user of the communication device 106 and/or 108, as will be appreciated by those skilled in the art.

An illustrative description of exemplary operation of the apparatus 100 is presented, for explanatory purposes. The mobile user of the mobile communication device 104 in one example considers a user of the communication device 106 to be a non-preferred user, for example, an acquaintance or business contact, and considers a user of the communication device 108 to be a preferred user, for example, a family member or close friend. The mobile user of the mobile communication device 104 employs the interface and/or the identifier of the communication device 108 to assign the member to the feature group. For example, the mobile user inputs one or more phone numbers of the family member to assign the family member to the feature group. The mobile switching center 102 stores the feature group in the subscriber database 110.

In one example, the non-preferred user of the communication device 106 initiates an incoming call to the mobile user of the mobile communication device 104. The communication device 106 in one example sends an initial address message (“IAM”) that comprises the identifier of the communication device 106 to the mobile switching center 102 to initiate the call. The mobile switching center 102 determines if the non-preferred user is a member of the feature group. For example, the mobile switching center 102 queries the subscriber database 110 for the feature group. The mobile switching center 102 compares the identifier with the feature group to make the determination. The mobile switching center 102 provides the communication feature to the mobile user based on the determination.

In another example, the preferred user of the communication device 108 initiates a call 118 to the mobile user of the mobile communication device 104. The communication device 108 in one example sends an initial address message that comprises the identifier of the communication device 108 to the mobile switching center 102 to initiate the call. In another example, the preferred user inputs an identifier, for example, a dual tone multi frequency digit pattern, during the call 118, for example, upon a voicemail prompt or busy signal. The mobile switching center 102 determines if the preferred user of the communication device 108 is a member of the feature group. The mobile switching center 102 provides the communication feature to the mobile user based on the determination.

In one example where the communication feature comprises a call waiting feature, the mobile switching center 102 receives an incoming call 114 from the non-preferred user of the communication device 106. The feature group comprises a call waiting feature group. The mobile switching center 102 determines that the incoming call 114 is not from a member of the call waiting feature group. The mobile switching center 102 communicates a first indication to the mobile user, for example, a default call waiting indication, to provide the communication feature to the mobile user.

In another example where the communication feature comprises a call waiting feature, the mobile switching center 102 receives an incoming call 118 from the preferred user of the communication device 108. The mobile switching center 102 determines that the incoming call 118 is from a member of the call waiting feature group. The mobile switching center 102 communicates a second indication to the mobile user, for example, a preferred call waiting indication, to provide the communication feature to the mobile user.

The mobile switching center 102 in one example cooperates with the mobile communication device 104 to provide an interface to the mobile user that allows the mobile user to input a selected duration. The mobile switching center 102 increases a duration of the second indication by the selected duration. For example, a first indication comprises a duration of five seconds, and the mobile user inputs a selected duration of ten seconds. The mobile switching center 102 communicates the second indication to the mobile user for fifteen seconds. In a further example, the interface allows the mobile user to assign one or more call waiting indications to the call waiting feature group. The mobile user is able to distinguish a preferred user from a non-preferred user by the call waiting indication and will have more time to answer the incoming call, as will be appreciated by those skilled in the art.

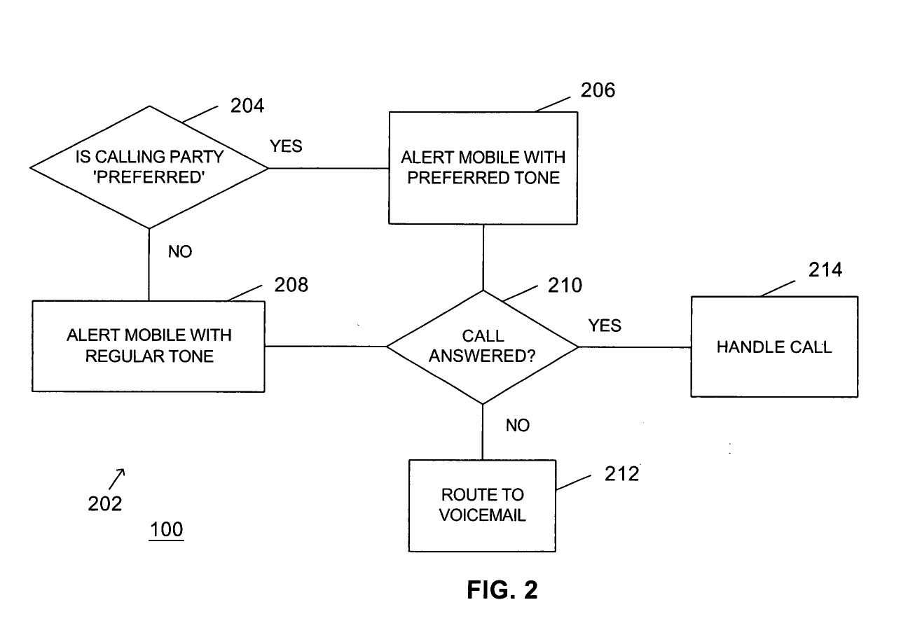

Turning to FIG. 2, a logic flow 202 comprises a logic flow for the call waiting feature. The mobile switching center 102 receives an incoming call from a calling party and determines if the calling party is a member of the call waiting feature group (STEP 204). The mobile switching center 102 queries the subscriber database 110 to determine if the calling party is a member of the call waiting feature group. If the calling party is a member of the call waiting feature group, the mobile switching center 102 communicates a preferred call waiting indication to the mobile user of the mobile communication device 104 (STEP 206). If the calling party is not a member of the call waiting feature group, the mobile switching center 102 communicates a default call waiting indication to the mobile user of the mobile communication device 104 (STEP 208).

The mobile switching center 102 determines if the incoming call is answered by the mobile user (STEP 210). If the mobile user does not answer the incoming call, the mobile switching center 102 will route the incoming call to a voicemail prompt. If the mobile user answers the incoming call, the mobile switching center 102 will handle the call with the call waiting feature, as will be appreciated by those skilled in the art.

Turning to FIG. 3, an exemplary message flow 302 comprises a message flow for the call waiting feature. The mobile communication device 104 is engaged in a pre-existing call with the communication device 106. The communication device 106 comprises a terminal to the public switched telephone network 304 (“PSTN”). The preferred user of the communication device 108 initiates an incoming call to the mobile communication device 104. The mobile switching center 102 receives the incoming call (STEP 1).

The mobile switching center 102 queries the subscriber database 110 for the call waiting feature group (STEP 2). The subscriber database 110 sends the call waiting feature group to the mobile switching center 102 (STEP 3). The mobile switching center 102 determines that the preferred user of the communication device 108 is a member of the call waiting feature group and communicates a preferred call waiting indication to the mobile user of the mobile communication device 104 (STEP 4). The mobile switching center 102 communicates a ringback tone to the preferred user of the communication device 108 (STEP 5).

The mobile user of the mobile communication device 104 answers the incoming call (STEP 6). The mobile switching center 102 places the communication device 106 on hold, and connects the communication device 108 with the mobile communication device 104 (STEP 7). The mobile user and the preferred user engage in a conversation (STEP 8). Upon completion of the conversation, the preferred user hangs up (STEP 9). The mobile switching center 102 reconnects the communication device 106 with the mobile communication device 104 (STEP 10).

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. Examples of a computer-readable signal-bearing medium for the apparatus 100 comprise the recordable data storage medium 112 of the mobile switching center 102, and the recordable data storage medium 112 of the subscriber database 110. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
a mobile switching center that allows a user of a mobile communication device to assign one or more members to a feature group that is employable by the mobile switching center to provide a communication feature to the user.

2. The apparatus of claim 1, wherein the feature group comprises a feature group for the communication feature, wherein the mobile switching center cooperates with the mobile communication device to provide an interface to the user that allows the user to assign the one or more members to the feature group for the communication feature.

3. The apparatus of claim 2, wherein the interface comprises one or more of a voice interface, a dual tone multi frequency (DTMF) interface, a graphical interface, a keypad interface, and a touchpad interface.

4. The apparatus of claim 1, wherein the mobile switching center makes a determination that a calling user is one of the one or more members assigned to the feature group;
wherein the mobile switching center provides the communication feature to the user based on the determination that the calling user is one of the one or more members assigned to the feature group.

5. The apparatus of claim 4, wherein the mobile switching center queries a subscriber database to make the determination that the calling user is one of the one or more members assigned to the feature group.

6. The apparatus of claim 1, wherein the communication feature comprises a call waiting feature, wherein the mobile switching center allows the user of the mobile communication device to assign the one or more members to the feature group for the call waiting feature.

7. The apparatus of claim 6, wherein the mobile switching center makes a determination that a calling user is one of the one or more members assigned to the feature group for the call waiting feature.

8. The apparatus of claim 7, wherein the mobile switching center employs a calling party number of the calling user to make the determination that the calling user is one of the one or more members assigned to the feature group for the call waiting feature.

9. The apparatus of claim 7, wherein the mobile switching center receives a DTMF digit pattern from the calling user;
wherein the mobile switching center employs the DTMF digit pattern from the calling user to make the determination that the calling user is one of the one or more members assigned to the feature group for the call waiting feature.

10. The apparatus of claim 7, wherein the mobile switching center communicates a first indication to the user of the mobile communication device if the calling user is one of the one or more members assigned to the feature group;
wherein the mobile switching center communicates a second indication to the user of the mobile communication device if the calling user is not one of the one or more members assigned to the feature group.

11. The apparatus of claim 10, wherein the mobile switching center cooperates with the mobile communication device to provide an interface to the user that allows the user to assign the first indication and the second indication.

12. The apparatus of claim 10, wherein the mobile switching center increases a duration of the second indication based on the determination that the calling user is one of the one or more members assigned to the feature group for the call waiting feature.

13. The apparatus of claim 12, wherein the mobile switching center cooperates with the mobile communication device to provide an interface to the user that allows the user to input a selected duration;
wherein the mobile switching center increases the duration of the indication by the selected duration.

14. A method, comprising the steps of:
identifying a calling user as one of one or more members of a user-defined feature group for a communication feature; and
performing the communication feature on an incoming call from the calling user.

15. The method of claim 14, wherein the incoming call from the calling user comprises an incoming call for a mobile communication device, wherein the step of identifying the calling user as one of the one or more members of the user-defined feature group for the communication feature comprises the steps of:
receiving the incoming call from the calling user for the mobile communication device;
making a determination that the calling user is one of the one or more members assigned to the user-defined feature group.

16. The method of claim 15, wherein the step of making the determination that the calling user is one of the one or more members assigned to the user-defined feature group comprises the steps of:
querying a subscriber database for the user-defined feature group;
comparing an identifier of the calling user with the identifier listing to determine if the user-defined feature group comprises the identifier.

17. The method of claim 15, further comprising the steps of:
receiving one or more inputs from a user of the mobile communication device to assign the one or more members to the user-defined feature group;
storing the user-defined feature group in the subscriber database.

18. The method of claim 17, wherein the communication feature comprises a call waiting feature, the method further comprising the steps of:
obtaining one or more inputs from the user of the mobile communication device to assign one or more call waiting indications to the call waiting feature;
communicating the one or more call waiting indications based on the determination that the calling user is one of the one or more members assigned to the user-defined feature group.

19. An article, comprising:
one or more computer-readable signal-bearing media; and
means in the one or more media for identifying a calling user as one of one or more members of a user-defined feature group for a communication feature; and
means in the one or more media for performing the communication feature on an incoming call from the calling user.

20. The article of claim 19, wherein the incoming call from the calling user comprises an incoming call for a mobile communication device, wherein the means in the one or more media for identifying the calling user as one of the one or more members of the user-defined feature group for the communication feature comprises:
means in the one or more media for receiving the incoming call from the calling user for the mobile communication device; and
means in the one or more media for querying a subscriber database to make a determination that the calling user is one of the one or more members assigned to the user-defined feature group.
